(19) United States
(12) Patent Application Publication
(10) Pub. No.: US 2008/0068463 A1
(43) Pub. Date: Mar. 20, 2008

(54) SYSTEM AND METHOD FOR GRAPHICALLY ENHANCING THE VISIBILITY OF AN OBJECT/PERSON IN BROADCASTING

(76) Inventors: Fabien Claveau, Quebec (CA); Benoit Debaque, Quebec (CA)

Correspondence Address: OGILVY RENAULT LLP, 1981 MCGILL COLLEGE AVENUE, SUITE 1600, MONTREAL, QC, H3A2Y3, US

(21) Appl. No.: 11/532,180

(22) Filed: Sep. 15, 2006

(51) Int. Cl. H04N 7/18; H04N 5/225

(52) U.S. Cl. 348/157; 348/169

(57) ABSTRACT

The present invention provides a system and a method for graphically enhancing the visibility of an object/person on a video image used in broadcasting a sport event. For broadcasting the sport event, one or a plurality of video camera acquire video images of the event. The object/person of which the trajectory is of relative importance in the sport game is generally in the field of view of the video camera but may or may not be visible on the images. When the object/person travels, a monitoring module passively tracks the object/person and measures the 3D position of the object/person. As the event is being broadcast, a graphical representation of the object or of its trajectory is depicted on the image to enhance the visibility of the object/person on the broadcast image.

### BACKGROUND OF THE INVENTION

1. Field of the Invention

The present invention relates to the video broadcast of sporting events and, more particularly, to graphically enhancing the perceptibility of objects/persons in the broadcast of sporting events.

2. Background Art

The broadcast of sport events has constantly evolved by the advent of new technologies in video equipment. Live footage from new points of view, high-resolution slow-motion replays and high-definition close-ups are a few examples of recent improvements to the broadcast of sporting events.

The use of graphics to enhance the visualization of the events has also significantly modified sports event broadcast. In addition to graphics displayed in replays to support the commentator's interventions, graphics have been added in real-time to depict movements of objects. For instance, in order to facilitate the viewing of the puck in hockey, a trajectory mark has been used to show puck displacement. The trajectory mark results form the use of transmitters inserted in the puck.

Similarly, virtual lines have been added as marker lines in the live broadcast of football games. For example, virtual lines mark the scrimmage line and the first-down line on the football field.

U.S. Pat. No. 5,413,345, issued to Nauck on May 9, 1995, describes a system utilizing an array of fixed high-speed video cameras to identify, track, display and record the path of golf balls. The tracking information is then displayed in video or audio replay. This system is primarily used in driving ranges, for instance to compare the trajectory of a ball with another ball or as a function of the swing of the golfer, and to show trajectory data in replay to the golfer. This system would require a very large number of cameras (with fixed orientation and zoom) in order to provide accurate 3-D positioning of a golf ball at an event which covers a large site (i.e., 18-hole tournament).

U.S. Pat. No. 6,449,010, issued to Tucker on Sep. 10, 2002, describes a system and method for enhancing the display of a sporting event, such as golf. In this system, video images are obtained from an overhead large field of view, for instance using a blimp. The video images are overlaid to present a trajectory of an object, which trajectory is represented in two dimensions upon background video images. This system does not provide 3-D positioning of the golf ball.

The webpage http://www.imagotrackers.com/pdf/ Imagolf_sv_fin.pdf (Jun. 28, 2006) describes a driving range trajectory system. In this system, a video camera unit is positioned behind the driver, and records video footage of a golfer and of a driven golf ball. A graphical display showing the trajectory of the ball may then be produced.

One of the issues with the prior art systems, is that none enable the video enhancement of the 3-D trajectory of the tracked object/person (i.e., golf ball) in real time. Another issue is that these prior art systems use dedicated video cameras which would have to be installed at the event venue in addition to the broadcasting cameras. Therefore, none has given rise to interest from the broadcasting industry, either for the absence of 3-D trajectory data, for the lack of precision in the calculation of trajectories, or for the lack of flexibility in their use.

### SUMMARY OF INVENTION

It is therefore an aim of the present invention to provide a system and method for enhancing the visualization of objects or persons in the broadcast of sporting events that addresses issues associated with the prior art.

The present invention is especially useful in situations where the object/person of interest is not visible because of limited camera resolution. For instance, during a golf tournament, it would be desirable to see in real time the complete trajectory of the shot while showing a global view of the golf hole.

Therefore, in accordance with the present invention, there is provided a system for graphically enhancing the position of an object/person on a video image used in broadcasting a sport event. The system comprises a video camera module having at least one video camera at the sport event venue for taking a video image for broadcasting the sport event, the video camera module providing view parameters associated with the video camera. The system also comprises a monitoring module passively tracking the object/person and measuring a three-dimensional position of the object/person in a global reference frame from the tracking and a broadcasting image processing unit connected to the video camera module and the monitoring module. The broadcasting image processing unit has a projection renderer and a graphical combiner. The projection renderer projects the three-dimensional position in the global reference frame to the video image by associating the view parameters to the global reference frame. The graphical combiner adds a graphical representation showing the projected position of the object/person on the video image in a broadcast output.

In accordance with the present invention, there is also provided a method for enhancing substantially in real-time the position of an object/person on a video image in broadcasting a sport event. The method comprises acquiring a video image of the object/person for live broadcast of the sport event; monitoring view parameters associating the video image to a global reference frame; measuring a three-dimensional position of the object/person in the global reference frame by passively tracking the object/person; projecting the three-dimensional position in the global reference frame to the video image using the view parameters; and graphically depicting the projected position on the video image in a broadcast output.

The present invention provides a system and a method for graphically enhancing the visibility of an object/person on a video image used in broadcasting a sport event. For broadcasting the sport event, one or a plurality of video camera acquire video images of the event. The object/person of which the trajectory is of relative importance in the sport game is generally in the field of view of the video camera but may or may not be visible on the images. When the object/person travels, a monitoring module passively tracks the object/person and measures the 3D position of the object/person. As the event is being broadcast, a graphical representation of the object or of its trajectory is depicted on the image to enhance the visibility of the object/person on the broadcast image.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a schematic illustrating a site where a sport event takes place along with a system for monitoring the position of an object/person, according to an embodiment of the invention;

FIG. 2 is block diagram illustrating a system for graphically enhancing the visibility of an object/person on a video image used in broadcasting a sport event, according to an embodiment of the invention,

FIG. 3 is a block diagram illustrating the components of the broadcasting image processing unit of the system of FIG. 2; and

FIG. 4 is a schematic view illustrating a graphical representation of the trajectory of an object/person superimposed on a video image of the sport event during a broadcast of the event.

### DESCRIPTION OF THE PREFERRED EMBODIMENTS

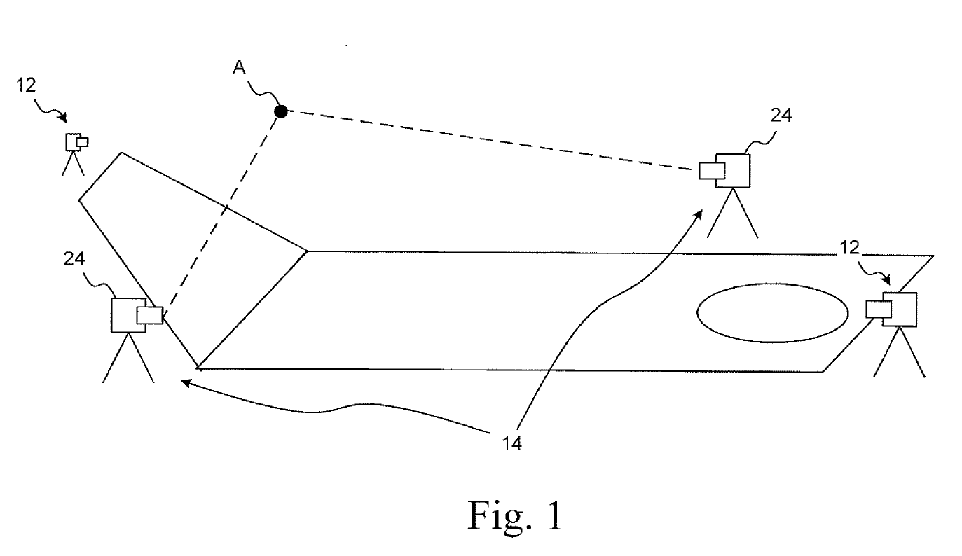

Referring now to the drawings and more particularly to FIG. 1, a system for monitoring the position of an object/person as positioned at a sport event venue is illustrated.

For broadcasting the sport event, one or a plurality of video camera modules 12 are taking video images of the event. The object/person A of which the trajectory is of relative importance in the sport game is generally in the field of view of the video camera module 12 but it may or may not be visible (i.e., perceptible) in the video images because of the limited resolution of the video images, for example. When the object/person A travels, a monitoring module 14 passively tracks the object/person and measures the 3D position of the object/person A in time. As the event is being broadcast, a graphical representation of the trajectory or a graphical representation showing the position of the object/person A as it travels is depicted on the image to enhance the visibility of the object/person A on the broadcast image.

As known in the art, passive tracking includes methods where no special modification is required to the object to be tracked. One example of a passive tracking method is a stereoscopic method. In stereoscopic methods, the object is tracked in video images using pattern recognition. Active tracking methods includes methods where the tracking is assisted by a transmitting device installed on the object to be tracked.

In the embodiment of FIG. 1, the monitoring module 14 uses a stereoscopic method. In order to provide 3D measurement, at least two tracking cameras 24 are provided at the sport event venue. The cameras are used for stereoscopic tracking, such that a minimum of two cameras (e.g., including video cameras and tracking cameras) is necessary to subsequently provide 3D measurement. Additionally, more than two tracking cameras can be used to cover a large site.

In the stereoscopic embodiment, the position, orientation and zoom (i.e., tracking parameters) of the tracking cameras 24 in a global reference frame are known such that the three-dimensional position of the object in the global reference frame is calculable using triangulation techniques. In this embodiment, the orientation and the zoom of the tracking cameras 24 are variable (e.g., operators manually handling the cameras) as the object/person A travels, to maintain the object/person A in the field of view of the cameras 24. In an alternative embodiment, the position of the tracking cameras 24 can also be varied. In any case, as the object/person A moves along its trajectory, the tracking parameters (position, orientation and/or zoom) are monitored. In an embodiment, the tracking cameras 24 are motorized and automatically controlled to track the object/person A as it travels along its trajectory. All tracking parameters need to be pre-calibrated using, for instance, a pattern recognition method and known physical locations (i.e., ground points).

As the event is being broadcast, the measured 3D positions of the object/person A are cumulated as a function of time to provide a 3D trajectory of the object/person. The measured 3D position or trajectory is projected on the video image and a graphical representation of the trajectory or of the actual position of the object/person A is drawn on the image to enhance the visualization of the object/person A on the broadcast image. The graphical representation may be a curve, series of points, ghost of the object/person A or such, showing the trajectory of the object/person A or it may be a point or an image of the object/person A showing only the actual position of the object/person A. In an embodiment, the graphical representation of the trajectory is drawn in real-time on the video image, i.e., the up-to-date trajectory is graphically added to the video image as the object/person A travels. Alternatively, the graphical representation of the trajectory could appear on the video image at the end of the trajectory, e.g. when the ball arrives at destination (e.g., touches the ground) or when the athlete reaches the finish line.

In order to perform the projection, the view parameters (i.e., the position, orientation and zoom) of the video camera module 12, which provides the broadcast footage, are monitored in the global reference frame. In this embodiment, the orientation and zoom of the video camera module 12 are varied to select the appropriate view for broadcasting the event and the view parameters are monitored. Alternatively, the video cameras 18 could be fixed. In any case, all view parameters need to be pre-calibrated using, for instance, a pattern recognition method and known physical locations (i.e., ground points).

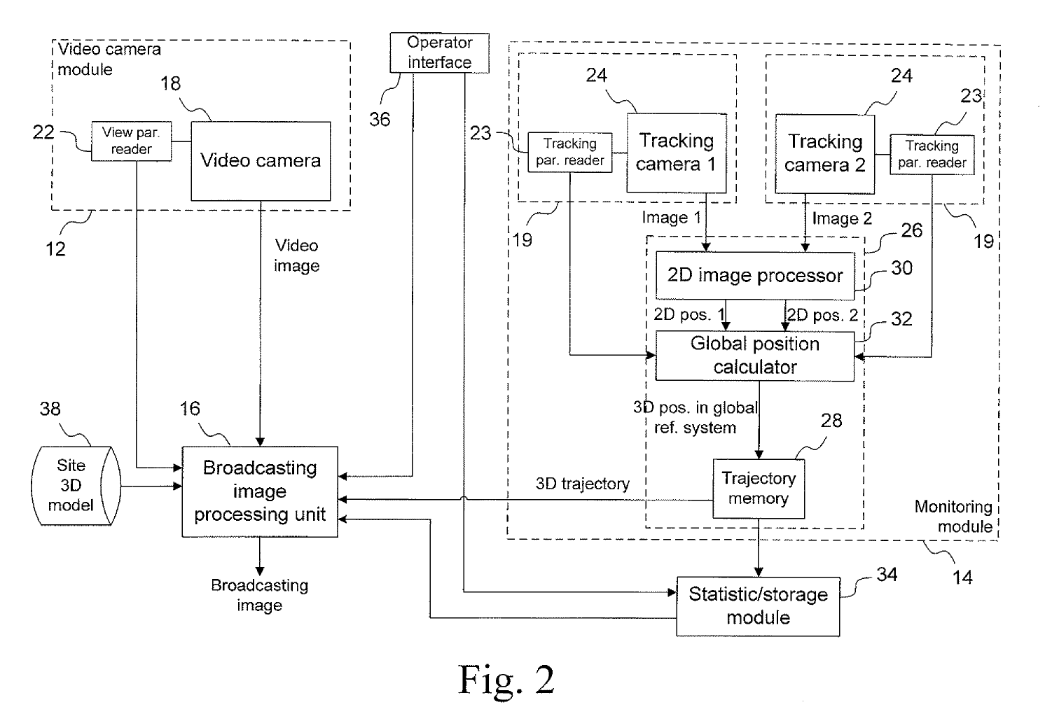

FIG. 2 illustrates a system 10 for graphically enhancing the visibility of an object/person on a video image used in broadcasting a sport event according to an embodiment. The system 10 comprises a video camera module 12, a monitoring module 14, a broadcasting image processing unit 16 and a statistic/storage module 34.

The video camera module 12 is provided for taking a video image framing the object/person for live broadcast of the event. As previously stated, the object/person may or may not be visible (i.e., perceptible) in the video image taken by the video camera module 12.

The monitoring module 14 measures a 3D position of the object/person in time and provides the 3D trajectory of the object/person.

The broadcasting image processing unit 16 renders a graphical representation of the trajectory or a graphical representation showing the position of the object/person A as it travels, on the video image.

The statistic/storage module 34 stores a plurality of object/person trajectories obtained at the sport event.

The video camera module 12 comprises at least one video camera 18. Images from a plurality of video cameras 18 can also be combined when producing the broadcast program. The view parameters of each video camera 18 can be varied (i.e., manually or automatically) as the location of the action of the game varies. More specifically, the position, orientation and/or the zoom of the camera are variable as a function of the footage gathered for the video broadcast.

Accordingly, a view parameter reader 22 is provided for each video camera 18 for reading the varying position, orientation and/or zoom. The view parameter reader 22 typically has encoders, inertial sensors and such for reading the orientation of the camera 18, and encoders for reading the zoom of the camera 18, i.e., the focal point of the camera's lens. In embodiments where the position of the video camera 18 is variable, the view parameter reader 22 typically has a positioning system (i.e., GPS or a local implementation).

The monitoring module 14 is a three-dimension measuring system. In an embodiment, the module 14 uses stereoscopy to measure the 3D trajectory of the object/person but any other 3D measuring method could alternatively be used. The monitoring module 14 uses at least two tracking camera modules 19 each having a tracking camera 24 for acquiring tracking images of the object/person, and an associated tracking parameter reader 23. The orientation and the zoom of the tracking cameras are controlled (e.g., manually) to allow an operator to follow the object/person A such that it is maintained in the field of view of the camera as it travels along the trajectory. The varying orientation and zoom of the tracking cameras in the global reference frame are monitored using the tracking parameter reader 23. Additionally, in an alternative embodiment, the position of the cameras can also be manually controlled and is monitored.

Like the view parameter reader 22, the tracking parameter reader 23 typically has encoders, inertial sensors and such for reading the orientation of the tracking camera 24, and encoders for reading the zoom of the tracking camera 24, i.e., the focal point of the camera's lens. In embodiments where the position of the tracking camera 24 is variable, the tracking parameter reader 23 also typically has a positioning system (i.e., GPS or a local implementation).

It is contemplated that, as the broadcast event goes on, the role of a video camera module 12 and of a tracking camera module 19 could be swapped at any time. Accordingly, at one time, a first camera could be used for providing the video image and, at another time, a second camera could be used for providing the video image while the first camera is used for providing a tracking image for measuring the position of the object/person.

A 3D trajectory processing unit 26 calculates the 3D position of the object/person A as it travels and comprises a trajectory memory 28, a 2D image processor 30, and a global position calculator 32. The 2D image processor 30 passively tracks the location of the object/person A in the tracking images using pattern recognition and provides a 2D position of the object/person in the image obtained from each of the cameras 24. The handling of the tracking cameras 24 for the tracking of the object/person A may be completely automated or may be operator assisted. For example, the operator could point out the position of the object/person on the image at the beginning of the trajectory, i.e., when the object/person A is still, and the 2D image processor 30 tracks the object/person A from that location.

The global position calculator 32 calculates the 3D position of the object/person in the global reference frame using triangulation techniques which are well known in the art. These methods basically use the 2D positions and the tracking parameters in order to obtain the 3D position of the object/person. The 3D positions are cumulated in the trajectory memory 28 to provide the 3D trajectory of the object/person A. The 3D trajectory is updated in real-time as the object/person travels and the up-to-date trajectory can thus be rendered on the broadcast image in real-time.

The broadcasting image processor 16 adds a graphical representation of the trajectory over the video image to be broadcast. Alternatively, a graphical representation showing the actual position only of the object/person A could only be added. The broadcasting image processor 16 is controlled by the operator of the system through a user interface 36. The operator may turn on and off the graphical representation and may add a statistic graphical representation as will be discussed further below.

In this embodiment, a 3D model 38 of the event venue is provided and taken into account in the graphic rendering. On segments of the trajectory where the object/person A is hidden by the 3D profile of the site (as seen by the video camera 18), the graphical representation is omitted. For example, if the object/person is behind a hill or a building, the trajectory is not drawn on the video image even though the trajectory is known (i.e., could be displayed). The 3D model 38 is thus used to improve the realism of the graphical representation.

As the sport event goes on, the various trajectories performed by various players or on various tries of the same player are typically stored in the statistic/storage module 34. This feature provides the option of superposing a graphical representation of the best up-to-date performance, for example, on the broadcast image for comparison purposes. The average performance of the actual player or any other trajectory may also be superposed. Superposing several trajectories on the live event image may also be performed, i.e., when the object/person starts its motion several trajectories are started at the same time and comparisons between several trajectories can be made in real-time. Any other statistic or numerical data that can be determined from the measured trajectory and that is relevant in the sport event can also be stored in the statistic/storage module 34. Such statistic includes the distance reached by the trajectory, the highest point of the trajectory, the maximum speed of the object/person along the trajectory, the time elapsed during the trajectory, etc.

An operator of the system controls the choices of displayed trajectories through an operator interface 36. The operator interface 36 is also used to associate each trajectory with the player that performed the trajectory and to other statistic data. The operator interface 36 can also be used to select between trajectory display and position display or between various styles of graphical representation.

It is contemplated that each 3D position may be stored in the trajectory memory 28 along with its associated time stamp for use, for example, in calculating statistic data. The data provided by the tracking camera modules 19 is preferably synchronized. Data provided by the video camera module 12 from at least one video camera and communications between the different modules of the system are preferably synchronized. It is contemplated that any appropriate synchronizing method known by one skilled in the art can be used.

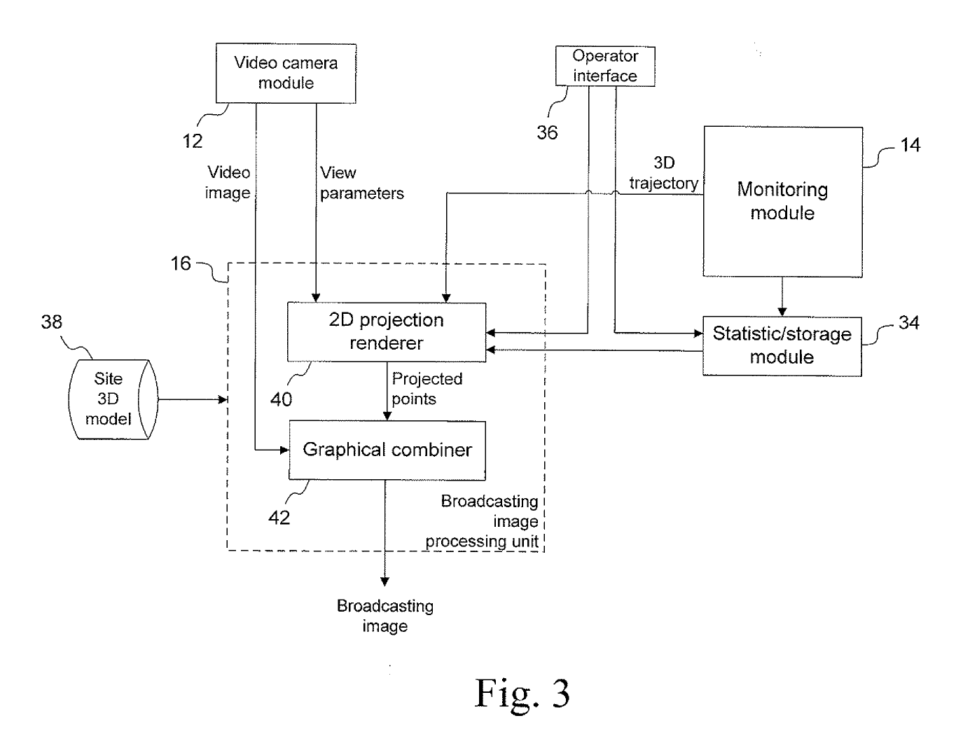

Referring to FIG. 3, greater detail is provided with regard to the broadcasting image processing unit 16. The broadcasting image processing unit 16 receives the 3D trajectory data from the monitoring module 14, as well as the video image from the video camera module 12.

The broadcasting image processing unit 16 comprises a 2D projection renderer 40 and a graphical combiner 42. The 2D projection renderer 40 receives the 3D trajectory and the view parameters and projects the 3D trajectory in the global reference frame on the video image. The graphical combiner 42 adds a graphical representation of the trajectory on the video image or a graphical representation showing the actual position only of the object/person.

In order to combine the trajectory/position information to the video image, a 2D projection renderer 40 must associate the video image to the global reference frame. As discussed previously, the view parameters of the video camera 18 are known, as provided by the video camera module 12.

Accordingly, with the position, orientation and zoom of the video camera 18 in the global reference frame, provided from the view parameters, the 2D projection renderer 40 determines the projection parameters associated with the video image within the global frame of reference. The 2D projection renderer 40 then projects the 3D trajectory using the same projection parameters. A projected trajectory is thereby provided as 2D points associated to the video image.

The graphical combiner 42 adds a graphical representation of the trajectory to the video image or, alternatively, a graphical representation showing the actual position of the object/person. The graphical representation can for instance be a realistic rendering of the object/person as it progresses along the trajectory, a curve depicting the projected trajectory (i.e., a curve passing through sampled 2D points) or dots distributed along the projected trajectory (i.e., located on selected 2D points). The broadcasting image is therefore the video image with a graphical display representing the trajectory or, alternatively, the object/person.

Moreover, statistic data is provided from the statistic/storage module 34 to the 2D projection rendered 40. As commanded through the operator interface 36, statistic information may be added to the video image using the graphical combiner 42.

The system 10 for enhancing the visibility of an object/person on a video image used in broadcasting a sport event has numerous contemplated uses. For example, the system can be used in broadcasting a golf game or tournament by drawing the trajectory of the golf ball in the air on the video image. It can also be used for visualizing the object thrown in broadcasting discus, hammer or javelin throw, for visualizing the trajectory of the athlete in ski jump, the trajectory of the ball hit in baseball or the trajectory of the kicked ball in football or soccer. Another example is the trajectory of the athlete in alpine skiing competition.

It should be contemplated that, if only the actual position of the object/person is to be graphically displayed on the broadcast image, a trajectory memory is not required and the broadcasting image processing unit can rather receive the actual 3D position of the object/person instead of the 3D trajectory.

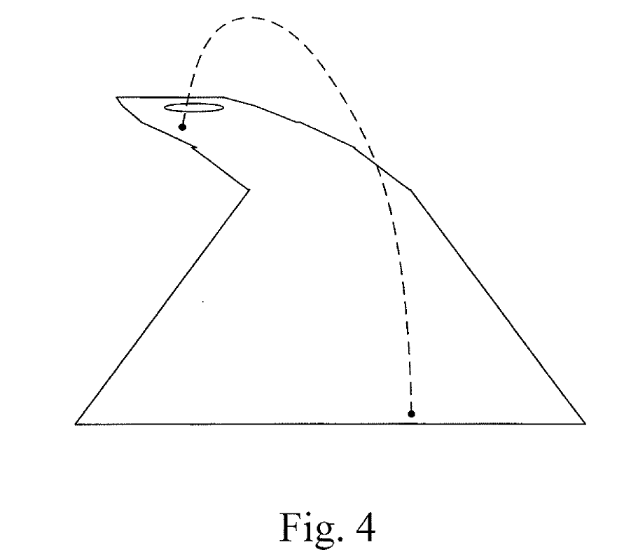

FIG. 4 illustrates an example of a graphical representation of the trajectory of an object/person superimposed on a video image of the sport event venue for broadcasting the event. In this example, the sport event is a golf tournament and the trajectory of a golf ball is displayed on a broadcast image. It should be appreciated that FIG. 4 is provided for illustration purposes and that, while a schematic of a golf hole along with the enhanced trajectory is shown in FIG. 4, a typical broadcast image would be a two-dimensional video image with a contrasting graphical representation of the trajectory.

While illustrated in the block diagrams as groups of discrete components communicating with each other via distinct data signal connections, it will be understood by those skilled in the art that the preferred embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

The embodiments of the invention described above are intended to be exemplary only. The scope of the invention is therefore intended to be limited solely by the scope of the appended claims.

1. A system for graphically enhancing the position of an object/person on a video image used in broadcasting a sport event, the system comprising:
a video camera module having at least one video camera at the sport event venue for taking a video image for broadcasting said sport event, the video camera module providing view parameters associated with the at least one video camera;
a monitoring module passively tracking said object/person and measuring a three-dimensional position of said object/person in a global reference frame from the tracking; and
a broadcasting image processing unit connected to the video camera module and the monitoring module, the broadcasting image processing unit having:
a projection renderer projecting said three dimensional position in said global reference frame to said video image by associating said view parameters to the global reference frame; and
a graphical combiner adding a graphical representation showing the projected position of said object/person on said video image in a broadcast output.

2. The system as claimed in claim 1, wherein said monitoring module has a trajectory memory cumulating said three-dimensional position in time to thereby provide a three-dimensional trajectory of said object/person in a global reference frame, said projection renderer further projecting said three-dimensional trajectory in said global reference frame to said video image, and said graphical combiner further adding a graphical representation of the projected trajectory on said video image.

3. The system as claimed in claim 1, wherein the trajectory monitoring module has at least two tracking camera modules each having one tracking camera at the sport event venue for tracking said object/person in tracking images, the tracking camera modules each providing tracking parameters associated with a respective one of the tracking cameras, and a trajectory processing unit receiving the tracking images from the tracking camera modules and measuring the three-dimensional position of said object/person in the global reference frame from the tracking images and the tracking parameters.

4. The system as claimed in claim i, wherein the graphical display of said three-dimensional position on said video image is depicted substantially in real-time.

5. The system as claimed in claim 3, wherein a single camera is used simultaneously as one of the tracking cameras of said trajectory monitoring module and as the video camera of the video camera module.

6. The system as claimed in claim 3, wherein the tracking camera modules each have a positioning system, whereby the position of the tracking camera of each said trajectory monitoring module is a tracking parameter associating the position of the tracking cameras to the global reference frame.

7. The system as claimed in claim 1, wherein said video camera module has a positioning system, whereby the position of the video camera of the video camera module is a view parameter associating the position of the tracking camera to the global reference frame.

8. The system as claimed in claim 1, further comprising a statistic module connected to the trajectory monitoring module, the statistic module independently storing trajectories of a plurality of object/person as statistic data, the statistic module being connected to the broadcasting image processing unit to provide the statistic data for broadcasting use.

9. The system as claimed in claim 8, wherein the statistic data is a graphical representation of at least one of said plurality of object/person trajectories, an up-to-date average trajectory and a best up-to-date performance trajectory on the video image.

10. The system as claimed in claim 1, further comprising a three-dimensional model source connected to the broadcasting image processing unit, the three-dimension model source provide a three-dimension model of the sport event site, such that the projection renderer combines the three-dimensional model of the site to the global reference frame to alter the graphical representation as a function of the site's topology.

11. A method for enhancing substantially in real-time the position of an object/person on a video image in broadcasting a sport event, the method comprising:
acquiring said video image of said object/person for live broadcast of said sport event;
monitoring view parameters associating said video image to a global reference frame;
measuring a three-dimensional position of said object/person in said global reference frame by passively tracking said object/person;
projecting the three-dimensional position in said global reference frame to the video image using the view parameters; and
graphically depicting the projected position on the video image in a broadcast output.

12. The method as claimed in claim 11, further comprising cumulating said three-dimensional position in time to thereby provide a three-dimensional trajectory of said object/person in a global reference frame, projecting said three-dimensional trajectory in said global reference frame to said video image, graphically depicting the projected trajectory on said video image.

13. The method as claimed in claim 11, wherein the step of measuring comprises obtaining tracking images of the object/person in the global reference frame and determining the three-dimensional position from the tracking images and tracking parameters.

14. The method as claimed in claim 13, wherein the tracking parameters include a variable position of a source of the tracking images with respect to the global reference frame.

15. The method as claimed in claim 12, further comprising independently storing trajectories of a plurality of object/person as statistic data.

16. The method as claimed in claim 11, wherein the step of projecting combining the three-dimensional trajectory to the video image further comprises combining a three-dimensional model of the sport event site to the video image to alter the projection as a function of the site's topology.
